(19) United States
(12) Patent Application Publication
(10) Pub. No.: US 2026/0139623 A1
(43) Pub. Date: May 21, 2026

(54) PORTABLE GAS TURBINE HEATER

(71) Applicant: CAHILL SERVICES OPERATING LLC, Livonia, MI (US)

(72) Inventors: Andrew Maxfield Mitchell, Ypsilanti, MI (US); Steven Lee Tracht, Chelsea, MI (US)

(73) Assignee: CAHILL SERVICES OPERATING LLC, Livonia, MI (US)

(21) Appl. No.: 18/987,820

(22) Filed: Dec. 19, 2024

Related U.S. Application Data
(60) Provisional application No. 63/721,993, filed on Nov. 18, 2024.

(51) Int. Cl. F02C 6/18; F02C 7/22

(52) U.S. Cl. CPC F02C 6/18; F02C 7/22; F05D 2220/64; F05D 2240/35

(57) ABSTRACT

A lightweight and portable heating unit produces heated air which is substantially breathable due to the burn efficiency of the unit. Fuel consumption is lower than known heating units. The disclosed unit incorporates micro turbine technology and a novel starting arrangement which relies on brushless DC motors coupled to a fan/turbine hybrid rotor which, after starting the unit, generate electrical power to sustain operation of the unit without the need for additional power input. The heating unit utilizes a dual inlet air filter system which minimizes the risk of dust and debris entering the system. The heating unit also provides a nozzle housing which utilizes incoming fuel to not only maintain service temperature but also to preheat the fuel prior to combustion. An additional feature of the present invention is the provision of an ejector which operates without the need for a fan or other complicated mechanical support system while efficiently providing dilution air.

### TECHNICAL FIELD

The present disclosure relates generally to portable heaters for use in various industrial, manufacturing, and construction settings. More particularly, the present disclosure provides an efficient and portable heater having an advanced starting arrangement coupled to an improved combustor which provides pre-heating of the fuel, thereby contributing to the efficient atomization of fuel.

### BACKGROUND OF THE INVENTION

Portable heating units have been used for many years to heat spaces which are typically large and which do not have their own HVAC system such as for industrial climate control or which are under construction and have not yet had an HVAC system installed. In addition to the general purpose of heating large spaces, portable heating units are often used in de-icing, ground thawing, heating wells, pipeline thermal expansion, and equipment and pipe thawing. Portability of the heating units is also valuable in the construction of tall buildings. The efficient curing of cement allows workers to move from floor to floor as the cement floors are cured.

Known systems typically rely on liquid gas or diesel fuels. The typical portable heater has certain inefficiencies in part due to the restricted choice but also due in part to the complicated designs of known systems. As a result, known portable heating units tend to use fuel inefficiently in operation, have a relatively high output of pollutants which creates challenges when heating a closed environment, and can be expensive to maintain in large part due to their excessively complicated designs.

Accordingly, a need exists to provide a portable heating unit that is efficient in both operation and service and which produces a low amount of pollutants.

### SUMMARY OF THE INVENTION

The disclosed inventive concept provides a response to the need for an improved portable heating unit. The present invention provides a lightweight and portable heating unit which produces substantially breathable heated air due to the high burn efficiency of the unit which is better than 97% even under the most extreme operating conditions. Following a brief warm-up time, the disclosed unit ramps up to full speed in less time than known technologies which take upwards of several minutes to reach operating temperature. Fuel consumption is dramatically reduced thus providing a considerable operating cost savings to the operator. Low fuel consumption also contributes to less CO2 generation, and the exhaust catalyst system sufficiently reduces CO parts per million (PPM) values to below the OSHA and NIOASH upper limits for workspaces. The lower weight of the unit compared with known units allows for a high level of portability while minimizing towing concerns.

These advantages are possible due to the use of micro turbine technology which operates with only a minimum of maintenance and a novel starting arrangement which relies on brushless DC (BLDC) motors which, after starting the unit, generate electrical power to sustain operation of the unit without the need for additional power input. The disclosed heating unit utilizes a dual inlet air filter system which minimizes the risk of dust and debris entering the system at the worksite. The present invention also provides an advanced nozzle housing which utilizes incoming fuel to not only maintain service temperature but also to preheats the fuel prior to combustion. An additional feature of the present invention is the provision of an ejector which operates without the need for a fan or other complicated mechanical support system while efficiently providing dilution air. Given the several advanced design features of the disclosed heating unit, heated air can be delivered up to 500 feet away, allowing the operator to split the outputted air into several feeds.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 is a first perspective view of the gas turbine heater according to the disclosed inventive system;

FIG. 2 is top view of the disclosed gas turbine heater;

FIG. 3 is a second perspective view of the gas turbine heater according to the disclosed inventive system;

FIG. 4 is a third perspective view of the gas turbine heater according to the disclosed inventive system;

FIG. 5 is a perspective of the gas turbine heater according to the disclosed inventive system but show without the catalytic converter and the ejector;

FIG. 6 is a side view of the gas turbine heater according to the disclosed inventive system particularly illustrating the dual intakes, the plenum, the compressor, and the turbine;

FIG. 7 is a side view of the gas turbine heater according to the disclosed inventive system particularly illustrating the plenum, the compressor, the turbine, and a portion of the combustor;

FIG. 8 is a sectional view of the combustor;

FIG. 9 is view of the output side of the nozzle housing for use with the combustor, the nozzle housing shown in relation to the input end of the pipe leading from the compressor;

FIG. 10 is an alternative view of the output side of the nozzle housing included for diagrammatic purposes;

FIG. 11 is side view of the nozzle housing;

FIG. 12 is a sectional view of the housing taken along line 13-13 of FIG. 11;

FIG. 13 is a sectional view of the housing taken along line 14-14 of FIG. 10;

FIG. 14 is a sectional view of the housing taken along line 15-15 of FIG. 10;

FIG. 15 is a sectional view of the dual intakes; and

FIG. 16 is a perspective, partially exploded view of the twin starter motor electric fans illustrated in spaced apart relation relative to the plenum.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

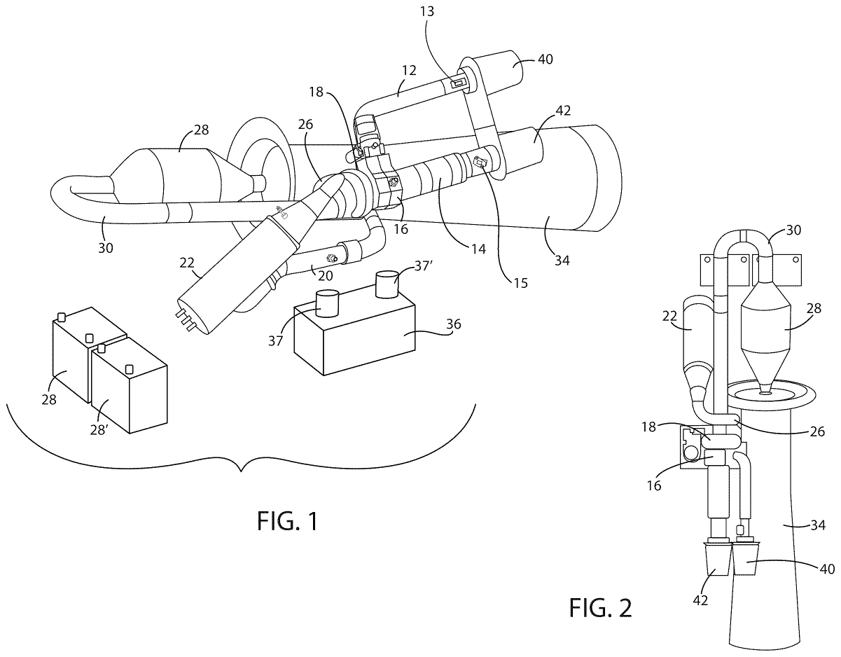

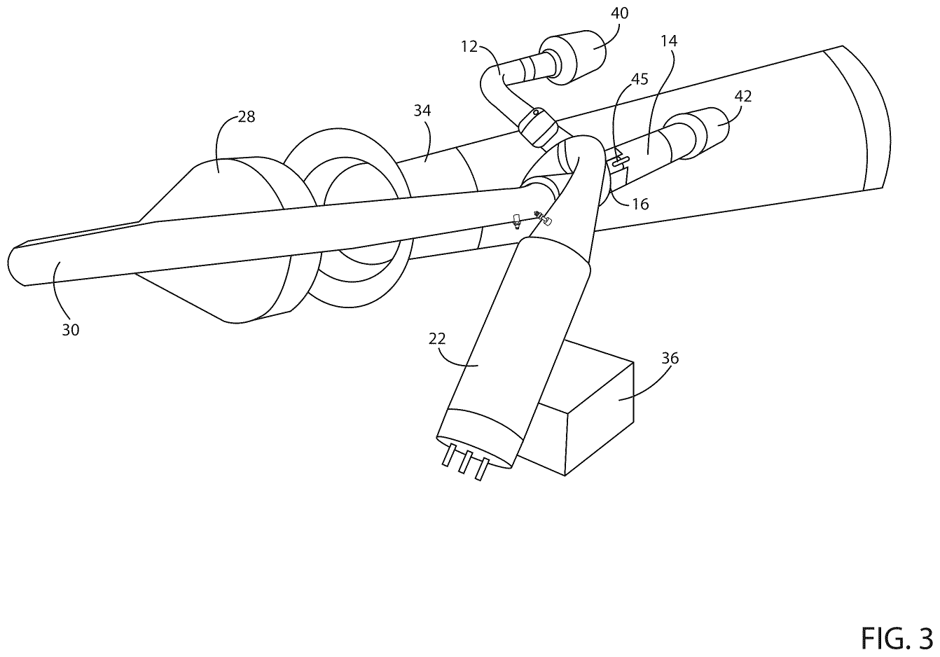

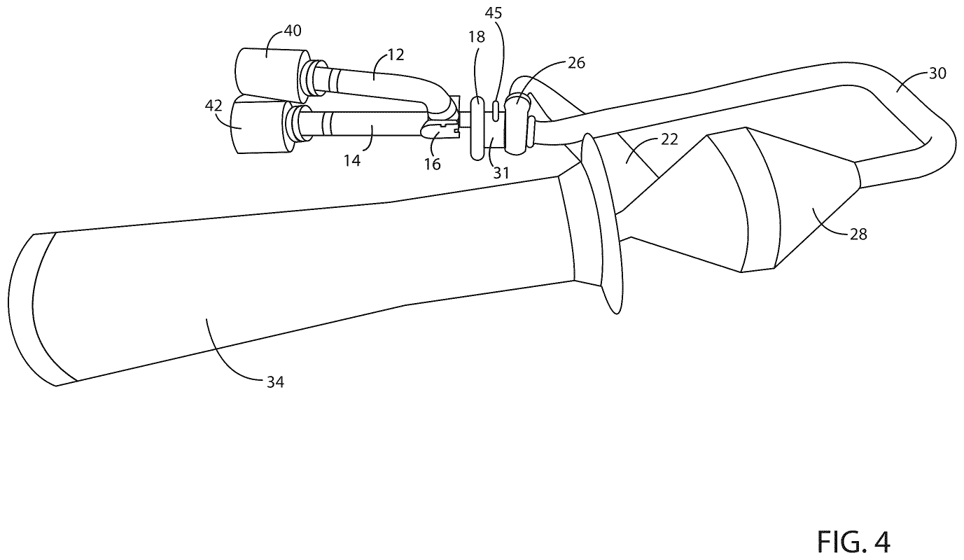

Referring to FIGS. 1-4, a gas turbine heater is illustrated in various views and is generally shown as 10. It is to be understood that the overall shapes, configurations, and placements of the components which comprise the heater 10 as illustrated are suggestive and are not intended as being limiting as variations may be possible without deviating from the inventive features of the present invention.

The gas turbine heater 10 includes a pair of spaced-apart fresh air inlets 12 (having a mass air flow sensor 13) and 14 (having a mass air flow sensor 15), a plenum 16 to which the air inlets 12 and 14 are attached, a compressor 18, a compressor outlet 20 which fluidly communicates compressed air to a combustor 22. The combustor 22 includes at one end a fuel nozzle 24 and at its other end a turbine 26 which forces hot air to a catalytic converter 28 by way of a hot air pipe 30. A central housing 31 is formed between the compressor 18 and the turbine 26. The catalytic converter 28 includes an exhaust end 32 which is spaced apart from an ejector 34. A programmed controller 36 is provided to regulate operation of the heater 10. The controller 36 includes one or more air intakes or breathers 37 and 37′ of which one is for gas and the other is for the lubrication system.

Power for the heater 10 may be from any of a variety of sources, but a preferred arrangement is to include rechargeable batteries 38, 38′ for operation. However, once started, the heater 10 provides its own power through an internal power generating arrangement as discussed below.

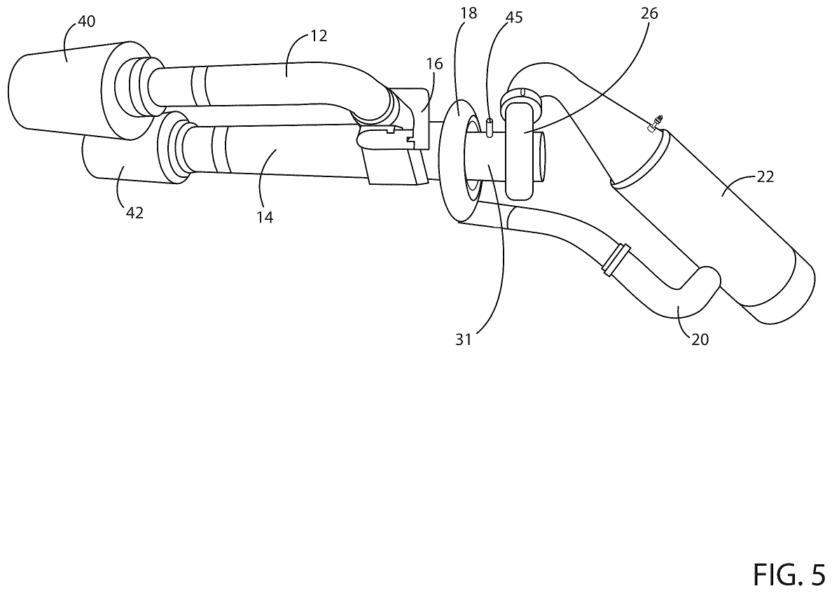

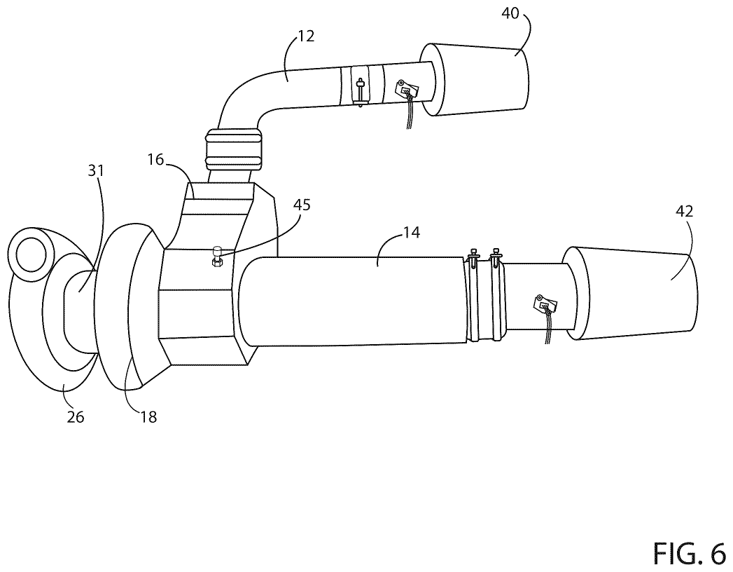

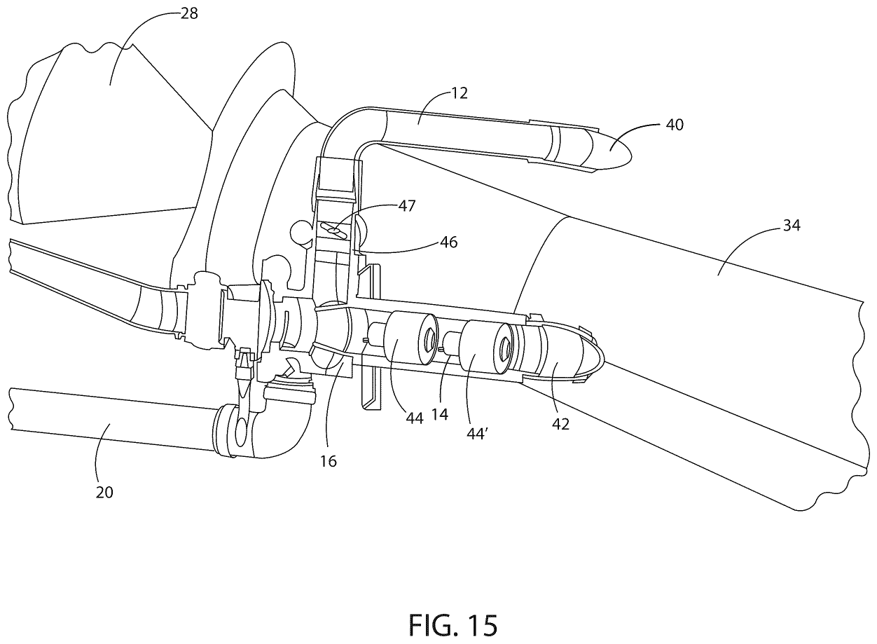

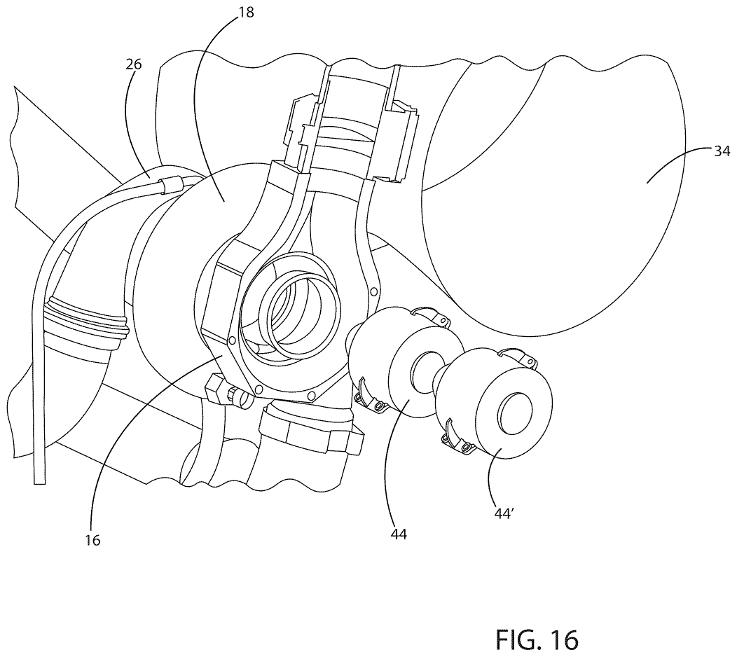

The spaced-apart fresh air inlets 12 and 14 provide two separate air inputs for the gas turbine heater 10. As illustrated in FIGS. 5 and 6, the fresh air inlets 12 and 14 are provided with filters 40 and 42 respectively. As discussed below with respect to FIG. 15, the fresh air inlet 14 includes a pair of spaced-apart coaxial fan/generator units 44 and 44′. The fresh air inlet 12 is provided to prevent the coaxial fan/generator units 44 and 44′ from becoming overcharged and possibly damage. The in-flow of air through the fresh air inlet 12 is regulated by an electrical throttle body 46 having a movable butterfly valve as shown in FIG. 15. The camber of the blades of the spaced-apart coaxial fan/generator units 44 and 44′ may be individually adjusted prior to installation of the units 44 and 44′ as needed for maximum fan operating efficiency.

The coaxial fan/generator units 44 and 44′ serve as starter motors for the gas turbine heater unit 10. Once the coaxial fan/generator units 44 and 44′ have achieved their operational running speeds, they then become wind turbines and function as generators due to the passage of air. Once in generator mode, the coaxial fan/generator units 44 and 44′ provide sufficient energy to power the gas turbine heater 10 thereby displacing the rechargeable batteries 38, 38′ for operation. Voltage rectification switches the coaxial fan/generator units 44 and 44′ from functioning as starter motors to power-generating turbines. Rectification may be effected by a rectifier built into the controller 36 or by another means. While starting the gas turbine heater unit 10 using the coaxial fan/generator units 44 and 44′ it is conceivable that the unit 10 may be started using, for example, an air blower or a motor, such as a TaG (Touch-and-go) engine. However, the design of the present invention avoids complexities of other starter arrangements, including geared starters and instead provides what is essentially a simplified push button start for the engine.

In operation, the coaxial fan/generator units 44 and 44′ are activated. At this point, the throttle body 46 is shut thereby blocking the passage of air through the fresh air inlet 12 and into the plenum 16. The compressor 18 is adjacent the plenum 16. The turbine wheel is preferably composed of an alloy consisting of nickel [about 25%] and chromium [about 15%] such as an Inconel® alloy, a superalloy which demonstrates high resistance to corrosion, oxidation, carburization, and pitting. Accordingly, the turbine 26 is capable of withstanding elevated heat greater than 800° C.

Once the coaxial fan/generator units 44 and 44′ are operating at their designating starting speeds, the mass air flow sensor 15 identifies the operating condition. The coaxial fan/generator units 44 and 44′ rely on an air flow to cause rotation of the compressor wheel of the compressor 18. The compressor 18 is fluidly connected to the combustor 22 through the compressor outlet 20. At this point, fuel is injected into the nozzle 24 and is ignited causing the turbine 26 to pick up speed on its own, thereby relying less and less on the coaxial fan/generator units 44 and 44′.

The throttle body 46 is then open thereby allowing fresh air to be drawn in simultaneously through both of the fresh air inlets 12 and 14. The coaxial fan/generator units 44 and 44′ are no longer powered but instead are rotating due to the passing air as noted above.

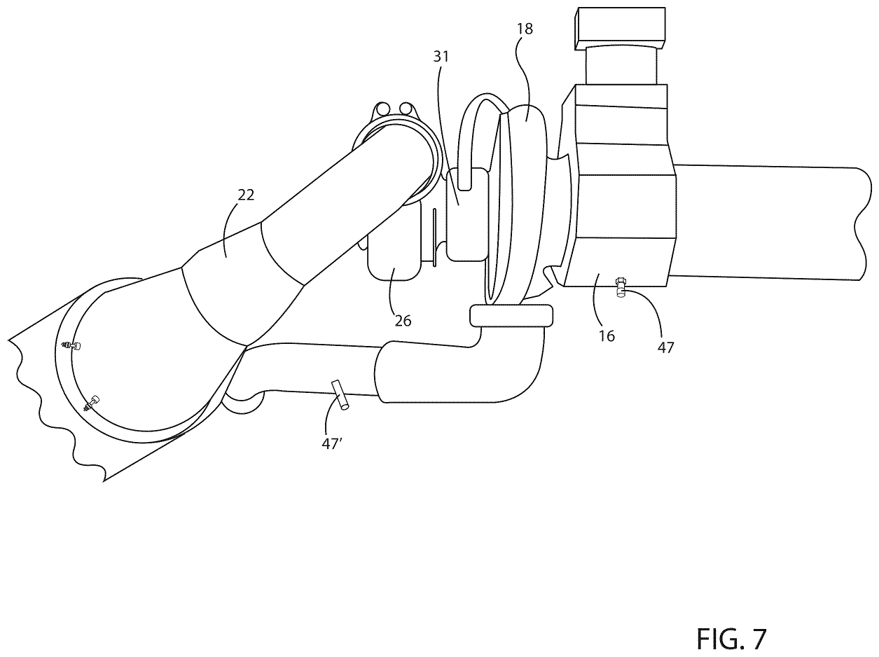

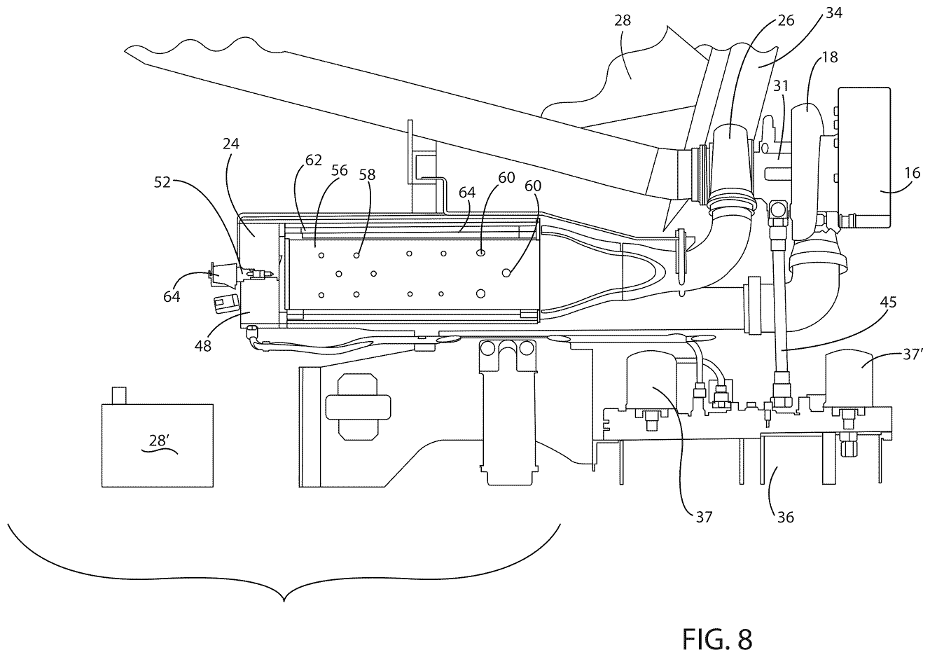

An oil input line 45 (shown particularly in FIG. 8) is provided and is connected to the central housing 31 of the turbocharger to provide adequate lubrication to the central housing. shown is connected to the plenum 16 to lubricate the rotating elements fitted within the plenum 16 and associated with the coaxial fan/generator units 44 and 44′. A pair of pressure sensors 47 and 47′ are also fitted in strategic locations on the gas turbine heater unit 10. The sensor 47 senses pressure as it enters the plenum 16 while the sensor 47′ senses pressure of the airflow as it exits the compressor 26. The pressure sensors 47 and 47′ monitor the correctness of the pressure ratio between the two sections of the gas turbine heater unit 10.

The turbine wheel of the turbine 26 is friction welded to a shaft which appears to be the same as the common drive shaft between the coaxial fan/generator units 44 and 44′. However, while the shafts are coaxial, they are not linked. However, the compressor 18 and the turbine 26 rotate at the same speeds where the relatively hot turbine 26 drives the relatively cold compressor 18. While the compressor 26 is initially driven by the coaxial fan/generator units 44 and 44′, because of the temperature differential, through an entropy drop the compressor 26 extracts mechanical work from the operation of the turbine 26, which, once heated, drives the gas turbine heater unit 10 to pressurize the hot air output.

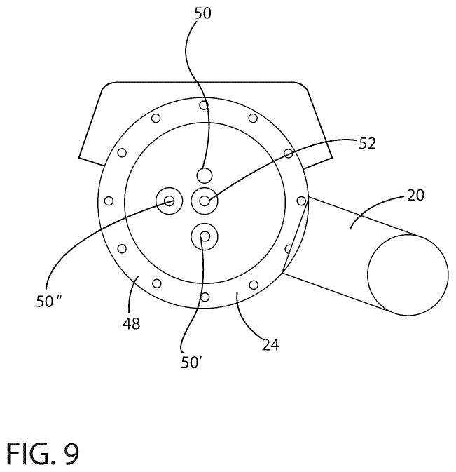

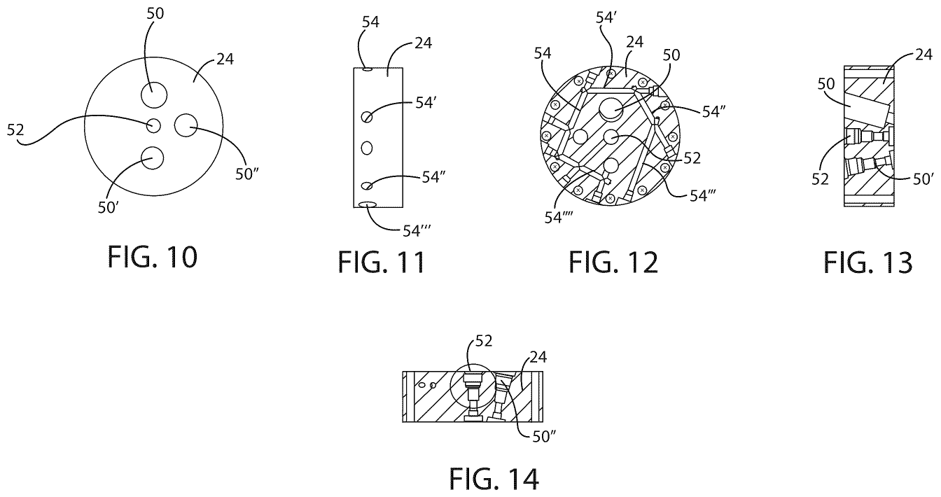

The fuel is introduced into the combustor 22 by way of the fuel nozzle 24 and its relationship to the combustor 22 is illustrated in FIGS. 8 through 14. Referring particularly to FIG. 12, the nozzle 24 includes a nozzle housing 48 having a series of inlets 50, 50′ and 50″ for fuel passage as well as a central igniter passageway 52 which are all provided front-to-back and through the nozzle housing 48. The nozzle housing 48 as well as a series of cross-channels 54, 54′, 54″, 54′″, and 54″″ formed horizontally within the nozzle housing 48. Fuel from the cross-channels 54, 54′, 54″, 54′″, and 54″″ is delivered to the combustor 22 which includes an elongated, tubular flame liner 56 having a plurality of strategically placed holes of different sizes, including a plurality of smaller primary holes 58 and a plurality of larger secondary and tertiary holes 60. An air space 62 is provided between the inner wall 62 of the combustor 22 and the flame liner 56. Air passes through the air space 62 and, due to the size variations of the holes 58 and 60, allows the air to enter the interior space of the combustor 22 in a controlled way. The smaller primary holes 58 are the primary holes where most of the incoming fuel is burned. The secondary and tertiary holes 60 allow for complete burn of any fuel not previously burned.

As an operational option, before the fuel arrives in the nozzle housing 48, it may be pressurized and heated to a temperature near the boiling point so that it becomes a gas for efficient burning when introduced into the combustor 22. Atomized fuel is ignited by an igniter 64. Accordingly, when the gas turbine heater unit 10 first begins operation, the nozzles formed in the housing 48 atomize the incoming fuel. However, as the combustor 22 achieves its preferred operating temperature, the incoming fuel becomes a gas which provides for a better and more complete burn.

The air heated in the combustor 22 is forced out of the combustor 22, through the hot air pipe 30, and after passing through the turbine stage of the engine, then flows into the catalytic converter 28 where the harmful CO and VOC byproducts of the combustion process are converted into CO2, whereby the outgoing heated air readily meets relevant OSHA and NIOASH standards. The purified air exits the catalytic converter 28 through its exhaust end 32 and is forced through and out of the ejector 34.

One skilled in the art will readily recognize from such discussion, and from the accompanying drawings and claims that various changes, modifications and variations can be made therein without departing from the true spirit and fair scope of the invention as defined by the following claims.

1. A gas turbine heater comprising:
a plenum;
a fresh air inlet attached to the plenum, wherein the fresh air inlet has a long axis;
a compressor to which the plenum is attached;
a combustor to which the compressor is attached
a turbine attached to the compressor;
a hot air pipe attached to the turbine;
a fan/generator unit in coaxial alignment with the long axis of the air inlet, the fan/generator unit being a combination of a fan and a generator integrally combined into a single unit, the single unit being selectively operable so as to run as either a fan or a generator; and
an external power source selectively operable to provide electrical power to the gas turbine when the fan/generator unit is operating as a fan.

2. The gas turbine heater of claim 1, further including a central housing positioned between the compressor and the turbine and wherein the combustor including an interior, the interior including a flame liner, the interior of the combustor including an inner wall formed on the combustor and a space formed between the flame liner and the inner wall, the flame liner including a plurality of fuel-passing apertures.

3. A gas turbine heater comprising:
a plenum;
a fresh air inlet attached to the plenum;
a compressor to which the plenum is attached;
a combustor to which the compressor is attached
a turbine attached to the compressor; and
a hot air pipe attached to the turbine.

4. The gas turbine heater of claim 3, wherein the fresh air inlet has a long axis and includes a fan/generator unit in coaxial alignment with the long axis of the air inlet.

5. The gas turbine heater of claim 4, wherein the fresh air inlet further includes a throttle body for regulating air flow.

6. The gas turbine heater of claim 4, wherein the fan/generator unit is a combination of a fan and a generator integrally combined into a single unit, the single unit being selectively operable so as to run as either a fan or a generator.

7. The gas turbine heater of claim 3, wherein two air inlets are attached to the plenum.

8. The gas turbine heater of claim 3, wherein the combustor includes a first end and a second end and wherein a fuel nozzle is attached to the first end and the turbine is attached to the second end.

9. The gas turbine heater of claim 3, further including a catalytic converter attached to the turbine.

10. The gas turbine heater of claim 9, wherein the catalytic converter includes an inlet end and an outlet end, the turbine being connected to the inlet end, the gas turbine further including an ejector.

11. The gas turbine heater of claim 3, further including a central housing positioned between the compressor and the turbine.

12. The gas turbine heater of claim 3, wherein the combustor includes an interior, the interior including a flame liner.

13. The gas turbine heater of claim 12, wherein the interior of the combustor includes an inner wall formed on the combustor and a space formed between the flame liner and the inner wall.

14. The gas turbine heater of claim 13, wherein the flame liner includes a plurality of fuel-passing apertures.

15. The gas turbine heater of claim 14, wherein the plurality of fuel-passing apertures are of different sizes.

16. The gas turbine heater of claim 15, wherein the fuel-passing apertures are provided in primary, secondary, and tertiary sizes which differ in size from one another.

17. The gas turbine heater of claim 5, further including an external power source which is selectively operable to provide electrical power to the gas turbine when the fan/generator unit is operating as a fan.

18. The method of operating a gas turbine heater, the method comprising:
forming a gas turbine heater which includes a program controller, an external power supply for initially operating the heater, a plenum, a fresh air inlet attached to the plenum, a compressor to which the plenum is attached, a combustor to which the compressor is attached, the combustor includes a first end and a second end and wherein a fuel nozzle is attached to the first end, a turbine attached to the compressor and to the second end of the combustor, a hot air pipe attached to the turbine, and a fan/generator unit positioned in the fresh air inlet, the fan/generator unit being a combination of a fan and a generator integrally combined into a single unit, the single unit being selectively operable so as to run as either a fan or a generator, the air inlet has a long axis, the fan/generator unit being in coaxial alignment with the long axis of the air inlet, the fresh air inlet further including a mass air flow sensor and a throttle body for regulating air flow;
closing the throttle body to block air flow through the fresh air inlet;
engaging the coaxial fan/generator unit to function as a fan and generates air flow which drives the compressor;
upon reaching a pre-designated speed, the mass air flow sensor identifies the operating condition which causes fuel to enter the combustor through the fuel nozzle;
igniting the fuel entering the combustor, the ignition of the fuel causing the turbine to rotate;
when the turbine achieves a certain rotational speed, the coaxial fan/generator ceases operation as a fan and switches to operation as a power generator by way of the air flow being drawn through the fresh air inlet; and
displacing the external power supply by operation of the coaxial fan/generator as a power generator.

19. The method of claim 18, further including a catalytic converter attached to the turbine, the catalytic converter including an inlet end and an outlet end, the turbine being connected to the inlet end, the gas turbine further including an ejector.

20. The method of claim 19, wherein the combustor includes an interior, the interior including a flame liner, and wherein the interior of the combustor further including an inner wall formed on the combustor and a space formed between the flame liner and the inner wall, the flame liner including a plurality of fuel-passing apertures.
